(19) United States
(12) Patent Application Publication
(10) Pub. No.: US 2011/0200039 A1
(43) Pub. Date: Aug. 18, 2011

(54) DEVICE CONTROL SYSTEM, DEVICE CONTROL METHOD AND CONTROL TERMINAL

(76) Inventor: Kyoichi Nakaguma, Yokohama (JP)

(21) Appl. No.: 12/907,679

(22) Filed: Oct. 19, 2010

(30) Foreign Application Priority Data
Feb. 15, 2010 (JP) 2010-029652

(51) Int. Cl. H04L 12/56

(52) U.S. Cl. 370/389

(57) ABSTRACT

A system interconnecting a server, a first control terminal and a second control terminal connected to a device, wherein the server includes: a device use unit for issuing device control information for the device; and a transmission unit for transmitting the device control information, the first control terminal includes: a transfer unit for receiving the device control information transmitted from the server and transferring the received device control information to the second control terminal, and the second control terminal includes a control unit for controlling the device connected to the second control terminal in accordance with the device control information received from the first control terminal.

### INCORPORATION BY REFERENCE

The present application claims priority from Japanese application JP2010-029652 filed on Feb. 15, 2010, the content of which is hereby incorporated by reference into this application.

### BACKGROUND OF THE INVENTION

The present invention relates to a device control system constituted of a plurality of communication terminals.

Users using the functions of a server are increasing more and more in the recent widespread of mobile information terminals such as mobile phones, network PC's connected to a network, televisions connected to the Internet, and the like. Needs particularly for making a server control a USB device connected to a control terminal have been steadily increased.

In order to satisfy these needs, it is necessary to provide a mechanism for making a sever control a USB device connected to a control terminal. As a method of realizing this mechanism, applying techniques disclosed in JP-A-2008-004072 (US2007/0288623A1) allows a server to control a USB device connected to a control terminal. With this method, however, after a server acquires a privilege of controlling a USB device connected to a control terminal, other servers are impossible to acquire a privilege of controlling the USB device.

### SUMMARY OF THE INVENTION

An object of the embodiments is to realize a mechanism of allowing a device connected to a control terminal to be controlled by a server via a relay terminal.

In a system interconnecting a server, a first control terminal and a second control terminal connected to a device,

the server includes:

a device use unit for issuing device control information for the device; and

a transmission unit for transmitting the device control information,

the first control terminal includes:

a transfer unit for receiving the device control information transmitted from the server and transferring the received device control information to the second control terminal, and

the second control terminal includes a control unit for controlling the device connected to the second control terminal in accordance with the device control information received from the first control terminal.

According to the embodiments, it becomes possible to remotely control a device connected to a control terminal.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram illustrating an example of a system.

FIG. 2 is a block diagram illustrating the configuration of a system including a server 11, a relay terminal 21 and a control terminal 22.

FIG. 3 illustrates examples of a table 400 and connection information 410.

FIG. 4 illustrates examples of route information 500 and connections 510.

FIG. 5 is a flow chart illustrating an example of a system operation.

FIG. 6 is a flow chart illustrating another example of a system operation.

FIG. 7 is a block diagram illustrating an example of a system according to a second embodiment.

### DETAILED DESCRIPTION OF THE EMBODIMENTS

Embodiments will now be described with reference to the accompanying drawings.

### First Embodiment

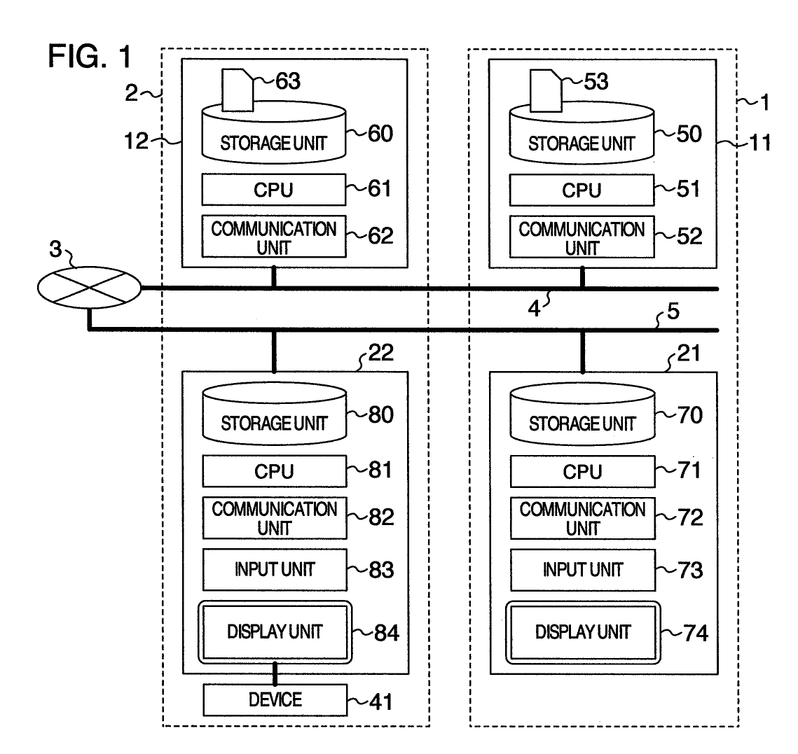

FIG. 1 is a block diagram illustrating an example of the configuration of a system. This system is constituted of servers 11 and 12, a relay terminal 21, a control terminal 22, the Internet 3, and wireless or wired communication paths 4 and 5.

A set of the server 11 and relay terminal 21 constitutes a thin client system 1. A set of the server 12 and control terminal 22 constitutes a thin client system 2. The control terminal 22 and relay terminal 21 may also be called as “client” or simply “computer”.

The server 11 is a control terminal apparatus of the thin client system 1, and is constituted of a CPU 51, a communication unit 52 and a storage unit 50. CPU 51 executes an application 53 stored in the storage unit 50. The server 12 is a control terminal apparatus of the thin client system 2, and is constituted of a CPU 61, a communication unit 62 and a storage unit 60. CPU 61 executes an application 63 stored in the storage unit 60.

The servers 11 and 12 are each a fixed computer such as a blade computer or a computer such as a main frame. The relay terminal 21 is a display of the thin client system 1, and is constituted of a CPU 71, a communication unit 72, a storage unit 70, an input unit 73, and a display unit 74.

Description will be made on the thin client system 1. The control terminal 21 as a client receives a user mouse operation or a user keyboard operation from an input unit 83 to acquire input information such as mouse pointer information and keyboard input information. A notification unit 305 transmits the input information to the server 11.

CPU 51 of the server 11 inputs the received input information to an operating system (OS) or an application to perform data processing. Image information corresponding to the data processing is generated and transmitted to the control terminal 21.

The control terminal 21 displays the image information from the server on a monitor or the like.

In this manner, input information input by the client is transmitted to the server and the server processes the input information to generate image information or the like, and returns the image information to the client to be displayed.

The control terminal 22 is a display of the thin client system 2, and is constituted of a CPU 81, a communication unit 82, a storage unit 80, an input unit 83, and a display unit 84. A device 41 is connected to the control terminal 22. It is possible to control the device 41 by a program to be executed by CPU 81, by a control unit 304 or by other components.

The device 41 is an apparatus capable of being dismounted from the control terminal and having a particular function. For example, the device may be an external storage unit such as a USB memory, a printer, a scanner, an authentication unit, a card reader/writer, a device reader/writer or the like. These devices are connected to the control terminal 22 by Universal Serial Bus (USB), High-Definition Multimedia Interface (HDMI) (registered trademark), IEEE1394 or the like.

Description will be made on an operation to be executed when a user of the control terminal 22 operates the device 41 connected to the control terminal 22 in a thin client system constituted of the control terminal 22 and server 11. For example, the device 41 is recognized by a control unit 304 of the control terminal 22 and controlled. Since this system is a thin client system, the control unit 304 recognizes the device 41, and thereafter transmits identification information on the device 41 to the server 11 via the notification unit 305.

A device use unit 100 of the server 11 recognizes the device from the received identification information on the device 41. The device 41 is therefore recognized just like a plurality of devices connected directly to the server 11, and displayed as one of the plurality of devices connected directly to the server 11.

A user operates a device displayed on a screen by using the input unit 83 of the control terminal 22. Input information such as input mouse coordinate information and input keyboard information is transmitted from the notification unit 305 to a notification unit 103 of the server 11. An OS, an application, a hardware or the like of the server 11 that received the input information executes a process corresponding to the input information. In accordance with this process executed, the device use unit 100 issues “device control information” such as a command for the device 41.

The device use unit 100 transmits the command to the control terminal 22 via a transfer unit 102. A transfer unit 303 of the control terminal 22 receives the command and sends the received command to the control unit 304. The control unit 304 executes a process corresponding to the command for the device 41.

As described above, in the thin client system, identification information on the device 41 is transmitted from the client to the server, so that it is possible for the server to recognize the device 41 just like a device directly connected to the server. The server issues a command for the device 41, and transfers the command to the client. The client executes a process corresponding to the command, so that it is possible for the server to operate the device 41.

The relay terminal 21 and control terminal 22 are apparatus having similar functions. A computer for relaying control information for the device 41 is simply called relay terminal 21, and a computer connected to the device 41 for receiving control information is simply called control terminal 22. If the device 41 is connected to the terminal 21 and the terminal 22 relays the control information, the terminal 21 is called a control terminal 21, and terminal 22 is called a relay terminal 22.

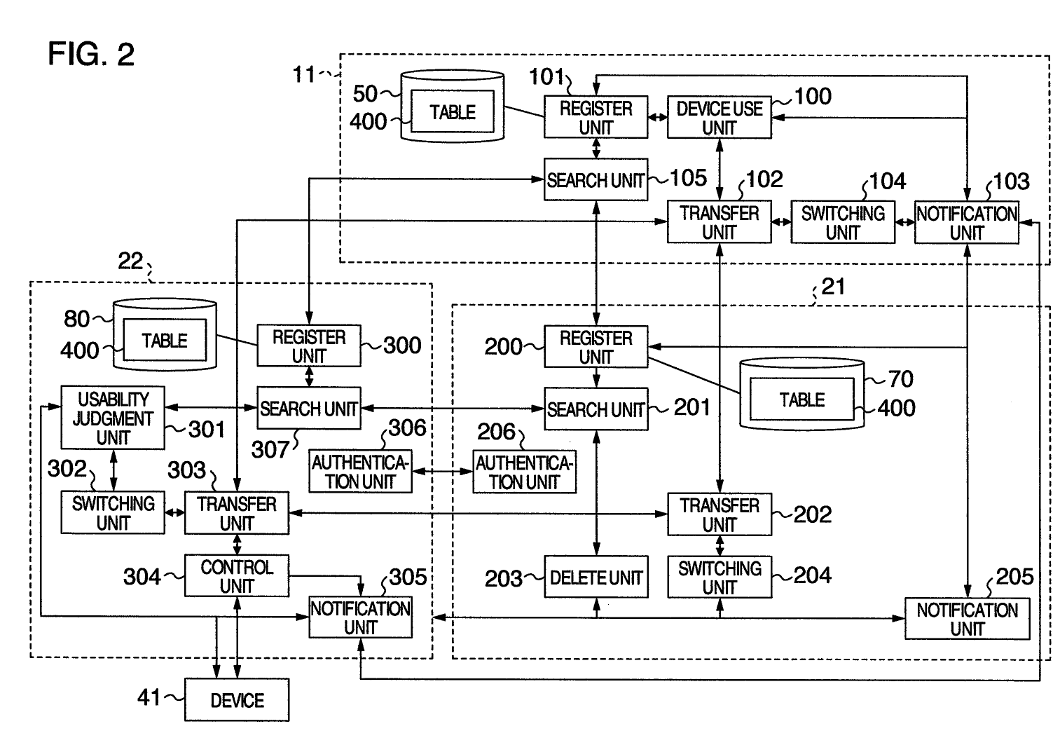

FIG. 2 is a block diagram illustrating an example of the configuration of the server 11, relay terminal 21 and control terminal 22 illustrated in FIG. 1.

The server 11 is constituted of a device use unit 100, a register unit 101, a transfer unit 102, a notification unit 103, a switching unit 104, and a search unit 105. The device use unit 100 controls the device 41 by using a driver for controlling the device 41.

The transfer unit 102 transmits/receives control information to be transmitted to/to be received from the device 41, by the device use unit 100, to/from the relay terminal 21 or control terminal 22. The register unit 101 generates connection information 410 representative of using the device 41, and registers the connection information 410 in a table 400 disposed in the storage unit 50.

The search unit 105 communicates with the register unit 200 of the relay terminal 21 or the register unit 300 of the control terminal 22 to inquire about whether the device 41 scheduled to be used by the device use unit 100 is connected to the terminal. The notification unit 103 receives the connection information 410 containing the search results. The switching unit 104 switches transmission/reception destinations of the control information from the transfer unit 102, in accordance with route information 500 recorded in the connection information 410.

Some or all of these units are realized by hardware by designing, for example, integrated circuits. The function of each unit may be realized by software by making CPU 51 execute the application 53 stored in the storage unit 50.

The relay terminal 21 is constituted of a register unit 200, a search unit 201, a transfer unit 202, a delete unit 203, a switching unit 204, and a notification unit 205, and an authentication unit 206. The transfer unit 202 transmits/receives control information to be transmitted to/to be received from the device 41, by the device use unit 100 of the server 11, to/from the transfer unit 102 of the server 11, and to/from a transfer unit 303 of the control terminal 22.

The register unit 200 updates the route information 500 of the connection information 410 sent from the search unit 105 of the server 11, and thereafter resisters the connection information 410 in the table 400 disposed in the storage unit 70. The search unit 201 communicates with the register unit 300 of the control terminal 22 to inquire about whether the device 41 scheduled to be used by the device use unit 100 is connected to the control terminal 22.

The notification unit 205 receives the connection information 410 containing the search results, and transmits the connection information to the notification unit 103 of the server 11. The switching unit 204 switches transmission/reception destination terminals of the control information from the transfer unit 202, in accordance with the route information 500 of the connection information 410. The delete unit 203 deletes the connection information 410 registered in the table 400 by the register unit 200, in accordance with the route information 500 of the connection information 410. The authentication unit 206 authenticates that it is possible to mutually communicate with the control terminal 22.

Some or all of these units are realized by hardware by designing, for example, integrated circuits. The function of each unit may be realized by software by making CPU 71 execute the application stored in the storage unit 70.

The control terminal 22 is constituted of a register unit 300, a usability judgment unit 301, a switching unit 302, a transfer unit 303, a control unit 304, a notification unit 305, an authentication unit 306, and a search unit 307. The control unit 304 connects the device 41 to control the device by transmitting/receiving control information.

The transfer unit 303 transmits/receives control information to be transmitted/received by the control unit 304 to/from the transfer unit 202 of the relay terminal 21 or the transfer unit 102 of the server 11. The register unit 300 updates the connection information 410 transmitted from the search unit 201 of the relay terminal 21, and thereafter registers the connection information in the table 400 disposed in the storage unit 80 of the control terminal 22.

The usability judgment unit 301 judges whether the device 41 is in use, and updates an in-use flag 424 of the connection information 410. The switching unit 302 switches transmission/reception terminals for the transfer unit 303, in accordance with the route information 500 of the connection information 410. At the timing when the control unit 304 starts controlling the device 41, the notification unit 305 transmits the connection information 410 registered by the register unit 300 to the notification unit 205 of the relay terminal 21.

The authentication unit 306 authenticates that it is possible to communicate with the relay terminal 21. The search unit 307 searches the table 400 stored in the storage unit 80 to check whether there exists the connection information 410 corresponding to the device 41.

Some or all of these units are realized by hardware by designing, for example, integrated circuits. The function of each unit may be realized by software by making CPU 81 execute the application stored in the storage unit 80.

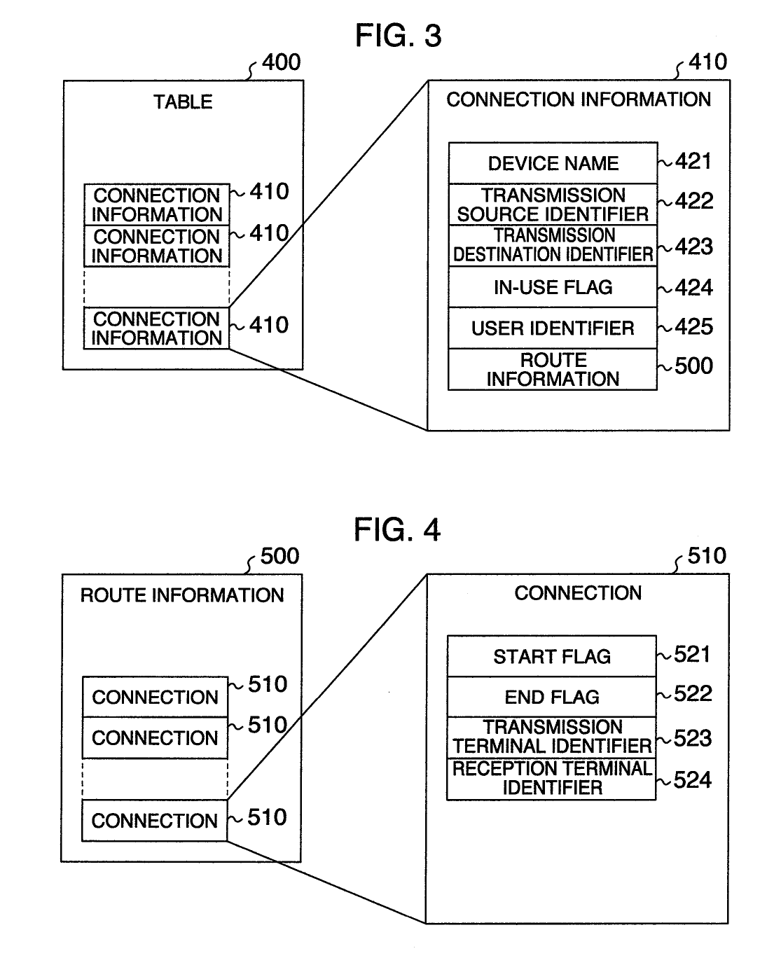

Next, description will be made on the table 400 stored in the storage units 50, 60, 70, 80, and 90 with reference to FIGS. 3 and 4.

FIG. 3 is a diagram illustrating an example of the table 400 and connection information.

The table 400 has one or a plurality of pieces of connection information 410. The storage units 50, 60, 70, 80 and 90 each have a table 400 in which connection information 410 is sequentially acquired and stored.

The connection information 410 includes a device name 421, a transmission source identifier 422, a transmission destination identifier 423, an in-use flag 424, a user identifier 425, and route information 500. The device name 421 represents a name of the device 41, and is an identifier capable of uniquely determining each device. The transmission source identifier 422 is an identifier for uniquely determining which of the server terminals controls the device designated by the device name 421. The device name 421 may be a server terminal name or an IP address.

The transmission destination identifier 423 is an identifier for uniquely determining that the device designated by the device name 421 is connected to which client terminal and controlled by the control unit 304 of which client terminal. The transmission destination identifier 423 may be a client terminal name or an IP address. The in-use flag 424 is a flag indicating whether the device 41 designated by the connection information 410 is in use, and taking a logical value of true if in use and a logical value of false if not in use.

The user identifier 425 is an identifier for uniquely discriminating a user using the device 41. The user identifier 425 may be a user name or any information capable of uniquely discriminating human being such as an ID number.

FIG. 4 is a diagram illustrating an example of connection information and connections.

The route information 500 is information associated with the connection information 410 and storing therein route information indicating whether the control information for controlling the device is transmitted/received from which server terminal to which client. The route information 500 has a plurality of connections 510. The connection is information representative of a route from one server terminal to one client terminal.

The connection 510 has a start flag 521, an end flag 522, a transmission terminal identifier 523, and a reception terminal identifier 524. The start flag 521 indicates that the terminal designated by the transmission terminal identifier 523 is a server terminal for operating a device. If the transmission source identifier 422 of the connection information 410 and the transmission terminal identifier 523 take the same value, the start flag 521 takes a true value.

The end flag 522 indicates that the client terminal designated by the reception terminal identifier 524 is the control terminal 22 for controlling the device. If the transmission destination identifier 423 of the connection information 410 and the reception terminal identifier 524 take the same value, the end flag 522 takes a true value.

The transmission terminal identifier 523 is an identifier indicating that the control information for controlling the device 41 is sent from which server terminal. The transmission terminal identifier 523 may be a server terminal name or an IP address. The reception terminal identifier 524 is an identifier indicating that the control information for controlling the device is to be transmitted to which client terminal. The reception terminal identifier 524 may be a client terminal name or an IP address.

Description will now be made on the connections 510 which store the state in which the server 11 controls the device 41 connected to the control terminal 22 via the relay terminal 21, for example, in the example of the diagram of the system configuration illustrated in FIG. 2. In the server 11, the start flag 521 is true, the end flag is false, the transmission terminal identifier 523 is none, and the reception terminal identifier 524 indicates the relay terminal 21. In the relay terminal 21, the start flag 521 is false, the end flag is false, the transmission terminal identifier 523 indicates the server 11, and the reception terminal identifier 524 indicates the control terminal 22.

In the control terminal 22, the start flag 521 is false, the end flag is true, the transmission terminal identifier 523 indicates the relay terminal 21, and the reception terminal identifier 524 indicates none. The route information 500 stored in these connections 510 makes it possible to express that the server 11 controls the device 41 connected to the control terminal 22 via the relay terminal 21.

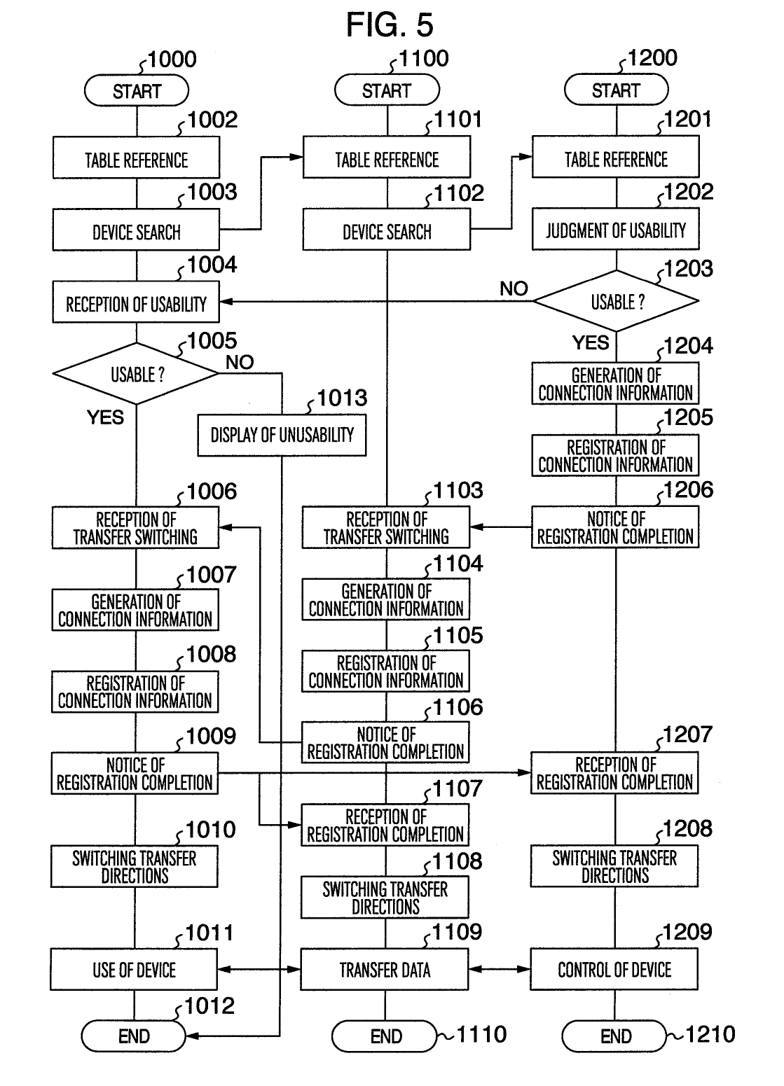

FIG. 5 is a flow chart illustrating an example of the operation of the system. In this embodiment, description will be made on the mechanism of allowing the server 11 to control the device 41 connected to the control terminal 22 via the relay terminal 21.

The server 11 executes a process 1000, the relay terminal 21 executes a process 1100, and the control terminal 22 executes a process 1200.

The search unit 105 of the server 11 refers to the table 400 stored in the storage unit 50 and searches the connection information 410 (S1002). The search unit 105 checks whether the device 41 to be used by the server 11 is coincident with the device name 421 of the connection information 410 recorded in the table 400 (S1003). If not coincident, the search unit 105 requests the relay terminal 21 to search the device 41 (S1101).

The search unit 201 of the relay terminal 21 searches the table 400 stored in the storage unit 70, and checks whether or not there exists the connection information 410 corresponding to the device 41 (S1101). If not, the search unit 201 requests the control terminal 22 to search the device 41 (S1201). The search unit 307 of the control terminal 22 searches the table 400 stored in the storage unit 80, and checks whether or not there exists the connection information 410 corresponding to the device 41 (S1201).

In this case, although the device 41 is connected to the control terminal 22, there is no connection information 410. Next, the usability judgment unit 301 inquires the device 41 about whether the device 41 is usable (S1202), and if unusable, this effect is notified to the server 11 via the notification unit 305 (No at S1203).

The notification unit 103 of the server 11 receives the usability information from the notification unit 305 of the control terminal 22 (S1004). If the usability information indicates an unusable state (S1005), the effect of the unusable state is displayed on the display unit (S1013) to thereafter terminate the process (S1012).

If it is judged at S1202 that the usability judgment unit 301 judges that the device 41 is usable (S1203), the register unit 300 generates the connection information 410. And at the same time, the register unit 300 registers device identification information on the device 41 acquired by the control unit 304 from the device 41, in the device name 421 of the connection information 410.

Further, the in-use flag 424 and user identifier 425 are added to the connection information 410. The register unit 300 adds the start flag 521, end flag 522, transmission terminal identifier 523 and reception terminal identifier 524 of the connection 510 to the route information 500 (S1204). Next, the register unit 300 registers the generated connection information 410 in the table 400 (S1205).

And, the notification unit 305 of the control terminal 22 transmits the connection information 410 to the relay terminal 21 (S1206). The notification unit 205 of the relay terminal 21 receives the connection information 410 (S1103), and the register unit 200 generates new connection information 410.

At the time of doing so, the register unit 200 adds the start flag 521, end flag 522, transmission terminal identifier 523 and reception terminal identifier 524 of the connection 510 to the connection information 410 as the route information 500 (S1104). Next, the register unit 200 registers the connection information 410 including the route information 500 in the table 400 of the relay terminal 21 (S1105), and the notification unit 205 notifies registration completion to the server 11 (S1106).

The notification unit 103 of the server 11 receives the connection information 410 (S1006), and the register unit 101 generates new connection information 410. At the time of doing so, the register unit 101 adds the start flag 521, end flag 522, transmission terminal identifier 523 and reception terminal identifier 524 of the connection 510 to the connection information 410 as the route information 500 (S1007).

Next, the register unit 101 registers the connection information 410 in the table 400 stored in the storage unit 50 (S1008). The server 11 recognizes the device 41 from the device name 421 described in the stored connection information 410, and makes the driver for the device 41 to be operable. The notification unit 103 transmits a registration completion notice to the relay terminal 21 and control terminal 22 (S1009).

At the timing when transmission is completed, the switching unit 104 switches transmission destinations of the control information to be transmitted/received by the transfer unit 102 of the server 11, in accordance with the route information 500 (S1010) to thereafter start using the device 41 (S1011). In the example of the system configuration illustrated in FIG. 2, the switching unit 104 acquires the route information 500 and switches the transmission destination to the relay terminal 21 designated by the reception terminal identifier 524.

At the timing when the connection information 410 is received (S1107), the switching unit 204 of the relay terminal 21 switches the transmission destinations of the control information to be transmitted/received by the transfer unit 202 of the relay terminal 21 (S1108), and the control information sent from the device use unit 100 of the server 11 is transferred (S1109). In the example of the system configuration illustrated in FIG. 2, the switching unit 204 acquires the route information 500 and switches transmission destinations in such a manner that information from the server 11 designated by the transmission terminal identifier 523 is transmitted to the relay terminal 21 designated by the reception terminal identifier 524.

At the timing when the connection information 410 is received (S1107), the switching unit 302 of the control terminal 22 switches the reception destinations of the control information to be transmitted/received by the transfer unit 303 of the control terminal 22 (S1108). In the example of the system configuration illustrated in FIG. 2, the switching unit 302 acquires the route information 500 and switches transmission destinations in such a manner that information from the relay terminal 21 designated by the transmission terminal identifier 523 is received. The control information is input to the control unit 304, and the control unit 304 transmits the control information to the device 41 to execute controlling of the device (S1209).

With the operations described above, it is possible to realize the mechanism of allowing the server 11 to control the device 41 connected to the control terminal 22 via the relay terminal 21.

The server 11 can acquire information on the device 41 connected to the control terminal 22 via the relay terminal 21. The device 41 is therefore displayed as one of a plurality of devices connected to the server 11.

Next, description will be made on a mechanism of reducing the number of relay terminals via which the device is controlled.

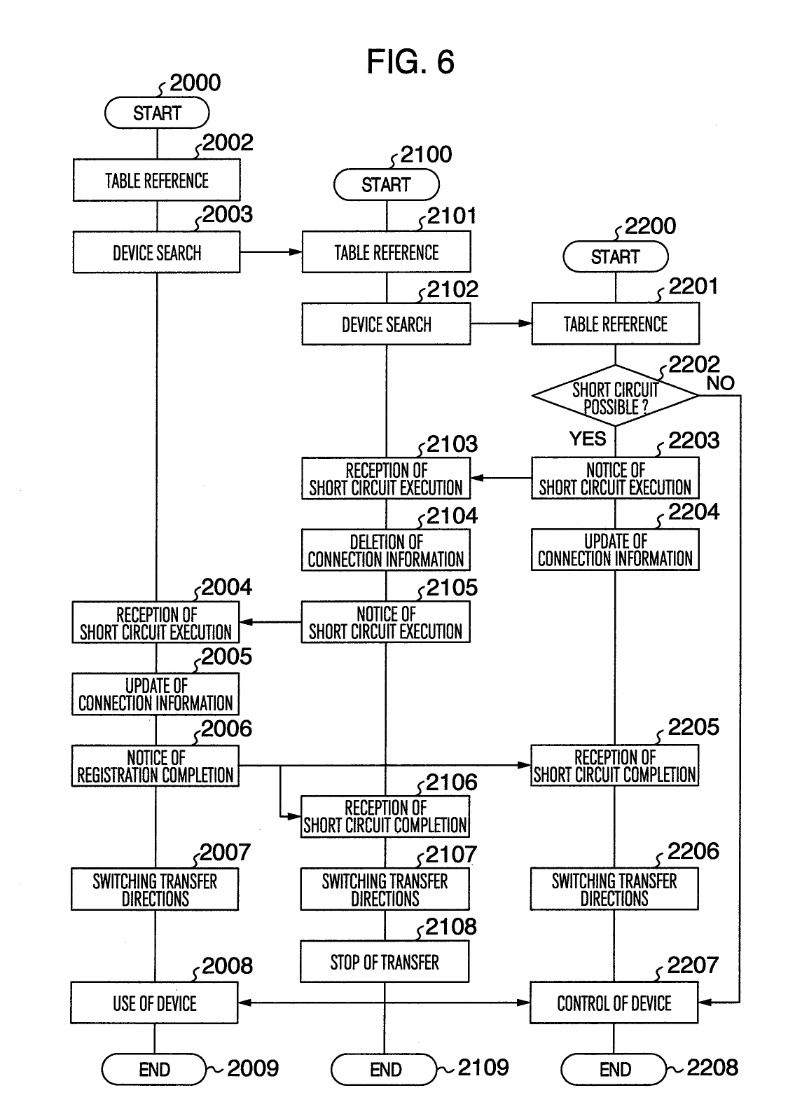

FIG. 6 is a flow chart illustrating an example of the operation of the system.

The server 11 executes a process 2000, the relay terminal 21 executes a process 2100, and the control terminal 22 executes a process 2200. Description will now be made with reference to the flow chart.

The search unit 105 of the server 11 refers to the table 400 stored in the storage unit 50 and searches the connection information 410 (S2002). The search unit 105 checks whether the device 41 to be used by the server 11 is coincident with the device name 421 of the connection information 410 recorded in the table 400 (S2003). If not coincident, the search unit 105 requests the relay terminal 21 to search the device 41 (S2101).

The search unit 201 of the relay terminal 21 searches the table 400 stored in the storage unit 70, and checks to see whether or not there exists the connection information 410 corresponding to the device 41. If not, the search unit 201 requests the search unit 307 of the control terminal 22 to search the device 41 (S2102). The search unit 307 of the control terminal 22 searches the table 400 stored in the storage unit 80, and checks to see whether or not there exists the connection information 410 corresponding to the device 41 (S2201).

If the connection information 410 is found, the search unit 307 checks the route information 500 in the connection information 410. From among the connections 510 having the start flag 521 of a true value, the search unit acquires a connection 510 whose transmission terminal identifier 523 is coincident with the transmission source identifier 422 of the connection information 410. From among the connections 510 having the end flag 521 of a true value, the search unit acquires a connection 510 whose reception terminal identifier 524 is coincident with the transmission destination identifier 423 of the connection information 410.

The search unit 307 judges that short circuit is possible at S2202, if the connections 510 can be acquired and it is confirmed that the device 41 is not used by other servers (S2202), to thereafter execute S2203. Confirmation on whether the device 41 is not used by other servers is realized if there is no in-use flag 424 representative of in-use among the connection information 410 having the device name 421 corresponding to the device 41.

If short circuit is impossible, S2207 is executed and the control unit 304 continues to control the device. The notification unit 305 of the control terminal 22 notifies the relay terminal 21 of the effect that short circuit is possible (S2203).

The register unit 300 arranges or organizes the connections 510, generates new connections 510 representative of direct connection between the server 21 and control terminal 22, and updates the connection information 410 (S2204). The notification unit 103 of the relay terminal 21 receives the effect that short circuit is executed, from the notification unit 305 of the control terminal 22 (S2103). Thereafter, the register unit 200 deletes the connection information 410 registered in the table 400 (S2104), and the notification unit 205 notifies this effect to the notification unit 103 of the server 11 (S2105).

The notification unit 103 of the server 11 receives information that short circuit is executed, from the notification unit 205 of the relay terminal 21 (S2004). The register unit 101 arranges or organizes the connections 510, generates new connections 510 representative of direct connection between the server 21 and control terminal 22, and updates the connection information 410 (S2005). The notification unit 103 notifies registration completion to the relay terminal 21 and control terminal 22.

The transmission/reception destination of information from the transfer unit 102 of the server 11 is switched to the transfer unit 303 of the control terminal 22 (S2007) to continue using the device (S2008). The notification unit 205 of the relay terminal 21 receives information that short circuit is executed (S2106). Thereafter, the transmission/reception destination of information from the transfer unit 202 of the relay terminal 21 is switched (S2107) to thereafter stop transferring the control information (S2108).

The notification unit 305 of the control terminal 22 receives information that short circuit is executed (S2205). The transfer unit 303 of the control terminal 22 switches the information transmission/reception destination to the transfer unit 102 of the server 11 (S2206). The control unit 304 controls the device (S2207).

With the operations described above, it becomes possible to realize the mechanism of reducing the number of relay terminals via which the device is controlled.

### Second Embodiment

The second embodiment will now be described.

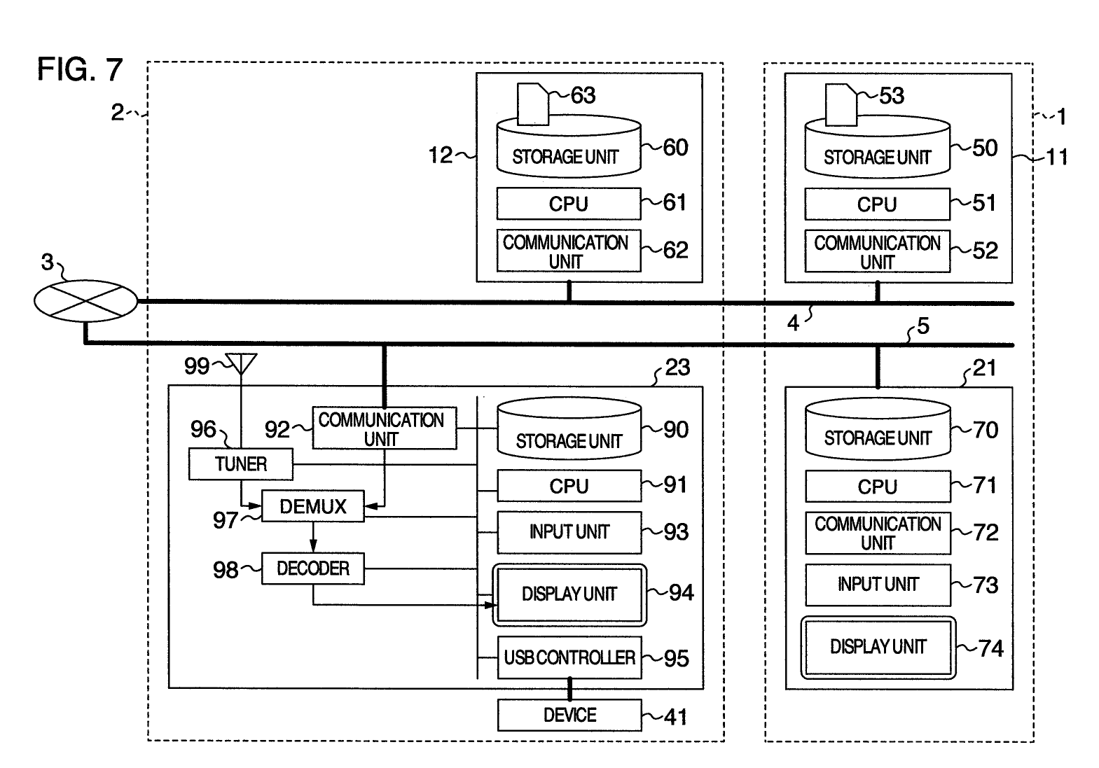

FIG. 7 is a block diagram illustrating an example of the system configuration. This system is constituted of servers 11 and 12, a relay terminal 21, a television set 23, the Internet 3, and wireless or wired communication paths 4 and 5. A set of the server 11 and relay terminal 21 constitutes a thin client system 1. Similarly, a set of the server 12 and television set 23 constitutes a thin client system 2.

The servers 11 and 12 and relay terminal 21 are the same as those described in the first embodiment. The television set 23 corresponds to the display of the thin client system 2 of the first embodiment, and is constituted of a CPU 91, a communication unit 92, a storage unit 90, an input unit 93, a display unit 94, a tuner 96 having a function of receiving TV pictures, a demultiplexer (DEMUX) 97, a decoder 98 and a device controller 95, having the same function as that of the control terminal 22.

A device 41 is connected to the television set 23, and can be controlled by an application running on CPU 91. If the television set is implemented by hardware, similar to the control terminal 22 illustrated in FIG. 2, the television set may have a register unit, a usability unit, a switching unit, a transfer unit, a control unit, a notification unit, an authentication unit and a search unit. Some or all of these units are realized by hardware by designing, for example, integrated circuits. The function of each unit may be realized by software by making CPU 91 execute an application stored in the storage unit 90.

The device 41 is an apparatus capable of being dismounted from the television set 23 and having a particular function. For example, the device may be an external storage unit such as a USB memory, a printer, a scanner, an authentication unit, a card reader/writer, a device reader/writer or the like. These devices are connected to the television set 23 by Universal Serial Bus (USB), High-Definition Multimedia Interface (HDMI) (registered trademark), IEEE1394 or the like. The device controller 95 corresponds to the control unit 304 illustrated in FIG. 2.

The tuner 96 tunes broadcast waves received by an antenna 99 to receive a radio wave. DEMUX 97 is an apparatus for acquiring a broadcast wave received by the tuner 96 or video information contained in Internet Protocol (IP) information received by the communication unit 92. The decoder 98 is an apparatus for processing video information acquired by DEMUX 97 to be displayed and for decoding cipher code.

The information acquired in this manner is sent to the display unit 94 so that the received broadcast wave or IP information can be displayed as moving images. The function of the second embodiment is the same as the description of the server 11, relay terminal 21 and control terminal 22 of the first embodiment illustrated in FIG. 2. The control terminal 22 of the first embodiment is replaced with the television set 23 of the second embodiment.

The relay terminal 21 is similar to the television set 23, and there is no functional difference. A television set for relaying control information for controlling the device 41 is simply called the relay terminal 21, and a television set connected to the device 41 for receiving control information is simply called the television set 23.

According to the second embodiment, by replacing the control terminal 22 with the television set 23, it becomes possible to realize a mechanism of allowing the server 11 to control the device 41 connected to the television set 23 via the relay terminal 21, and a mechanism of reducing the number of relay terminals 21 via which the device is controlled.

According to the embodiments, it becomes possible to remotely control the device connected to the control terminal. It is also possible to reduce the number of relay terminals 21 via which the device is controlled.

The present invention is not intended to be limited only to the above-described embodiments, but various modifications are inclusive. For example, detailed description of the embodiments is not intended to be limited to those containing all constituent elements. A portion of constituent elements of one embodiment may be replaced with constituent elements of another embodiment. A portion of constituent elements of one embodiment may be added to, deleted from or replaced with constituent elements of another embodiment.

Some or all of the above-described configurations, functions, units and the like may be realized by hardware by designing, for example, integrated circuits. Each of the above-described configurations and functions may be realized by software by making a processor analyze and execute a program realizing each function. Information on a program, a table, a file or the like realizing each function may be stored in a recording device such as a memory, a hard disc and a solid state drive (SSD) or a recording medium such as an IC card, an SD card and a DVD.

The control lines and information lines (i.e., lines carrying information) shown and described are limited only to those indispensable for describing the invention and are not necessarily all the control lines and information lines that are required for actual product. In actuality, it can be considered that almost all of the constituent elements are mutually connected to each other.

It should be further understood by those skilled in the art that although the foregoing description has been made on embodiments of the invention, the invention is not limited thereto and various changes and modifications may be made without departing from the spirit of the invention and the scope of the appended claims.

1. A device control system interconnecting a server, a first control terminal and a second control terminal connected to a device, wherein:
said server comprises:
a device use unit for issuing device control information for said device; and
a transmission unit for transmitting said device control information,
said first control terminal comprises:
a transfer unit for receiving said device control information transmitted from said server and transferring said received device control information to said second control terminal, and
said second control terminal comprises a control unit for controlling said device connected to said second control terminal in accordance with said device control information received from said first control terminal.

2. The device control system according to claim 1, wherein:
said first control terminal has route information including a transmission terminal identifier for identifying a transmission terminal for transmitting said device control information and a reception terminal identifier for identifying a reception terminal for receiving said device control information; and
said transfer unit of said first control terminal acquires said transmission terminal identifier and said reception terminal identifier from said route information, and transfers said device control information received from said server designated by said transmission terminal identifier to said second control terminal designated by said reception terminal identifier.

3. The device control system according to claim 1, wherein:
said second control terminal includes a second transmission unit for transmitting a device identification information for identifying said device acquired from said device to said server; and
said device use unit of said server recognizes said device in accordance with said transmitted device identification information.

4. The device control system according to claim 1, wherein:
said second control terminal includes a second transmission unit for transmitting a device identification information for identifying said device acquired from said device to said server; and
said device use unit of said server generates a screen for displaying said device in accordance with said transmitted device identification information.

5. The device control system according to claim 1, wherein said second control terminal includes:
route information representative of a transfer route of said device control information; and
a switching unit for switching a reception source of said device control information to said server, if it is confirmed from said route information that it is unnecessary for said first control terminal to transfer said device control information.

6. A device control method for a system interconnecting a server, a first control terminal and a second control terminal connected to a device, wherein
said server:
issues device control information for said device; and
transmits said device control information,
said first control terminal:
receives said device control information transmitted from said server and transfers said received device control information to said second control terminal, and
said second control terminal controls said device connected to said second control terminal in accordance with said device control information received from said first control terminal.

7. The device control method according to claim 6, wherein:
said first control terminal has route information including a transmission terminal identifier for identifying a transmission terminal for transmitting said device control information and a reception terminal identifier for identifying a reception terminal for receiving said device control information; and
said transfer unit of said first control terminal acquires said transmission terminal identifier and said reception terminal identifier from said route information, and transfers said device control information received from said server designated by said transmission terminal identifier to said second control terminal designated by said reception terminal identifier.

8. The device control method according to claim 6, wherein:
said second control terminal transmits a device identification information for identifying said device acquired from said device to said server; and
said server recognizes said device in accordance with said transmitted device identification information.

9. The device control method according to claim 6, wherein:
said second control terminal transmits a device identification information for identifying said device acquired from said device to said server; and
said server generates a screen for displaying said device in accordance with said transmitted device identification information.

10. The device control method according to claim 6, wherein said second control terminal switches a reception source of said device control information to said server, if it is confirmed, from route information representative of a transfer route of said device control information, that it is unnecessary for said first control terminal to transfer said device control information.

11. A first control terminal wherein a server and a second control terminal connected to a device are interconnected via a network, said first control terminal comprises:
a reception unit for receiving device control information transmitted from said server for controlling said device connected to said second control terminal; and
a transfer unit for transferring said received device control information to said second control terminal.

12. The first control terminal according to claim 11, wherein:
the first control terminal has route information including a transmission terminal identifier for identifying a transmission terminal for transmitting said device control information and a reception terminal identifier for identifying a reception terminal for receiving said device control information; and
said transfer unit acquires said transmission terminal identifier and said reception terminal identifier from said route information, and transfers said device control information received from said server designated by said transmission terminal identifier to said second control terminal designated by said reception terminal identifier.
